(19) United States
(12) Patent Application Publication
(10) Pub. No.: US 2003/0172195 A1
(43) Pub. Date: Sep. 11, 2003

(54) Method and system for guaranteeing sequential consistency in distributed computations

(76) Inventor: Henricus Bernardus Maria Jonkers, Eindhoven (NL)

Correspondence Address: U.S. Philips Corporation, 580 White Plains Road, Tarrytown, NY, 10591, US

(21) Appl. No.: 10/280,646

(22) Filed: Oct. 25, 2002

(30) Foreign Application Priority Data
Oct. 30, 2001 (EP) 01204140.6

(51) Int. Cl. G06F 9/46

(52) U.S. Cl. 709/315; 709/320

(57) ABSTRACT

Method for obtaining sequential consistency of data communications using a ‘commit-sync’ execution model, comprising the steps of:

transmitting data from a first process to an intermediate object or part thereof by a commit command,

setting an indicator of the intermediate object or part thereof to an indication that data is to be received or accessed by a second process,

receiving or accessing the data from the intermediate object by the second process by a sync command,

setting the indicator of the intermediate object or part thereof to an indication that no data is to be received or accessed by the second process, wherein

the commit command and/or the sync command is provided with one or more parameters to indicate in what way the data are transmitted to and/or received or accessed from the intermediate object, respectively.

The invention relates to methods guaranteeing sequential consistency. U.S. Pat. No. 6,182,152 (attorney docket PHN 015645) by the same applicant as the present application discloses a method and system for synchronizing concurrent sequential processes by means of intra-proces update operations and inter-process adapt operations, which works fine in case of intra-process data communications when several processors are being operated on a single computer or the like.

Furthermore, the invention relates to communication protocols using “two-phase locking”. Two-phase locking protocols, however, are known for the eventuality of dead lock and provide a relatively low efficiency.

The present invention provides a method for obtaining sequential consistency of data communications using a ‘commit-sync’ execution model, comprising the steps of:

transmitting data from a first process to an intermediate object or part thereof by a commit command,

setting an indicator of the intermediate object or part thereof to an indication that data is to be received or accessed by a second process,

receiving or accessing the data from the intermediate object by the second process by a sync command,

setting the indicator of the intermediate object or part thereof to an indication that no data is to be received or accessed by the second process, wherein

the commit command and/or the sync command is provided with one or more parameters to indicate in what way the data are transmitted to and/or received or accessed from the intermediate object, respectively.

Embodiments according to the invention enable data communication between processes in which communication delays can occur, which is often the case when processes operate on several computing devices which are interconnected by one or more computer networks.

Using parameters indicating how data is to be handled by the intermediate objects has the advantage that receiving or accessing the data can be done in a selective way. Such a parameterized receiving operation (SYNC) enables a process to “SYNC” only a selection of earlier transmitted data which are indicated by the intermediate object by means of the indicator. Data communications according to the method will be sequentially consistent once at least a requirement of fairness is being met by the connecting data communications network. The requirement of fairness is defined such that all the intermediate network nodes are reliable, which means that no data or data communications are being lost in the process of transmission. It is very advantageous that fairness is the only requirement for the method to function because any interconnecting network can be used disregarding network parameters such as speed or quality of service as long as communications or messages are not being lost.

In another preferred embodiment it is allowed that a sync operation includes parameters for accessing intermediate objects or parts thereof of which the indicator indicates that no data is to be received or accessed

In a further embodiment according to the invention the second process or receiving process reports reception of data to the transmitting process that sent the data. An advantage thereof is that the sending process knows that the message has arrived and another advantage is that the sender knows the intermediate object or part thereof which is used for the communication is “free” again, which means that the indicator of the intermediate object or part thereof is set to an indication that no data is to be received or accessed by the second process. Another effect is that the intermediate object or part thereof is “free” for a new “COMMIT”.

In another embodiment processes continue operating while transmitting. A commit operation has an effect on the global variables contained in the intermediate objects or parts thereof but it does not have any direct effect on the process executing the commit operation. For example, the commit operator does not return a value which can influence the execution of the process nor does it have to delay the process for synchronization purposes. This implies that if a process is to perform a commit action it can treat it as a kind of “background task” and simply continue with its normal execution. It does not have to block until the commit operation is completed before executing the next action as long as this action is a local action.

In another embodiment, processes use an interaction manager for managing transmit and receive operations. If a COMMIT is executing the background and the process requires to execute another COMMIT and continue with its execution, the system must somehow record that another COMMIT has to be executed after the one currently being executed. This can be dealt with by introducing an “interaction manager” that keeps track of the COMMITs still to be executed. This interaction manager can also be used to take care of the execution of SYNCs, thus moving the responsibility for the execution of interactions to a single authority. The use of a separate interaction manager per process has the advantage that the processes themselves do not need to have knowledge about the topology and performance of the network to optimize their interaction. This responsibility is localized in the interaction manager. The processes only provide the COMMIT and SYNC commands to the interaction manager which will handle them in an optimized way using the freedom allowed in the execution of COMMIT and SYNC. The interaction managers can also be used to optimize the communication between processes that reside in the same network node (the non-distributed case).

In another embodiment more than one transmitting operation is performed by a process simultaneously. A precondition for this is that the sets of intermediate object or parts thereof that are used by the simultaneous COMMIT operations are disjoint. Though logically a COMMIT should have been completed before the next COMMIT is executed, the interaction manager can already start the execution of the next COMMIT by sending the required data to the respective receivers of the intermediate object or parts thereof. Of course, before completing the last COMMIT, all logically preceding COMMITs should have been completed. If a COMMIT is in progress on an intermediate object or parts thereof and other COMMITs involving the same intermediate object or parts thereof are allowed to start, a possibly unlimited amount of data may have to be buffered at the receiving side of the intermediate object or parts thereof, which is undesirable. So far the protocol has not required any buffering at all. We therefore allow overlapping execution of COMMITs only if the sets of intermediate objects of parts thereof involved in the COMMITs are disjoint, implying that on each individual intermediate object or parts thereof at most one COMMIT can be in progress.

In a further embodiment the indicator is set immediately after transmission in the event that no other transmission was in progress when the transmission started.

A further aspect of the present invention relates to using a method according to the present invention in combination with distributed software components according to the co-pending European patent application serial no. 01204139.8 (attorney docket PHNL010785). Combining measures of both concepts has the advantage that the behavior of distributed components can be independent of a degree of distribution thereof. In other words, the combined measures allow systems to be designed without considering message delays. It guarantees that a system will functionally behave as if it applies “instant messaging” even in distributed situations.

Further advantages, features and details of the present invention will be illustrated in the light of the following description of a preferred embodiment thereof with reference to annexed drawings, in which:

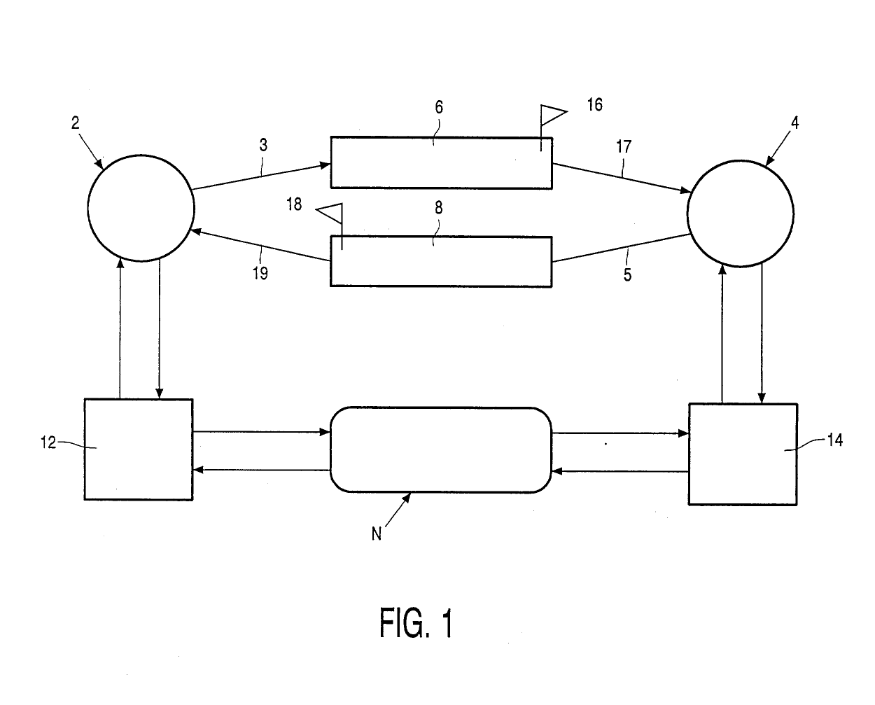

FIG. 1 shows a diagram of a preferred embodiment according to the invention;

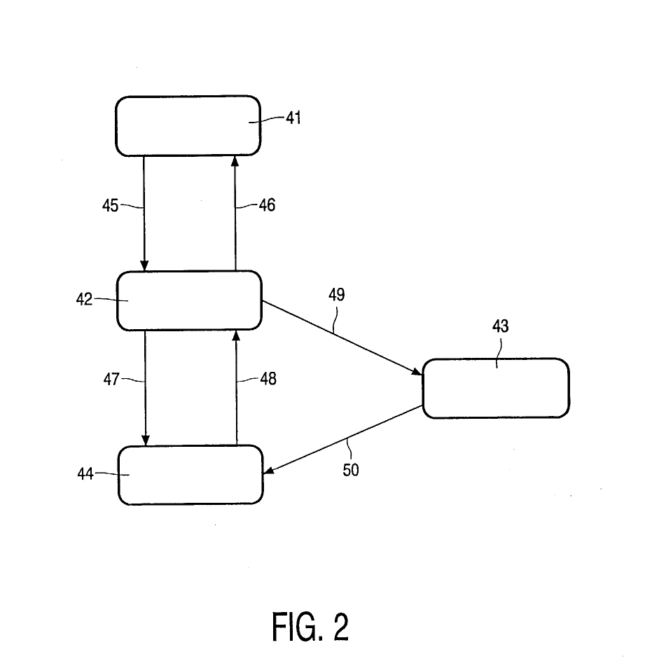

FIG. 2 is a diagram of another preferred embodiment;

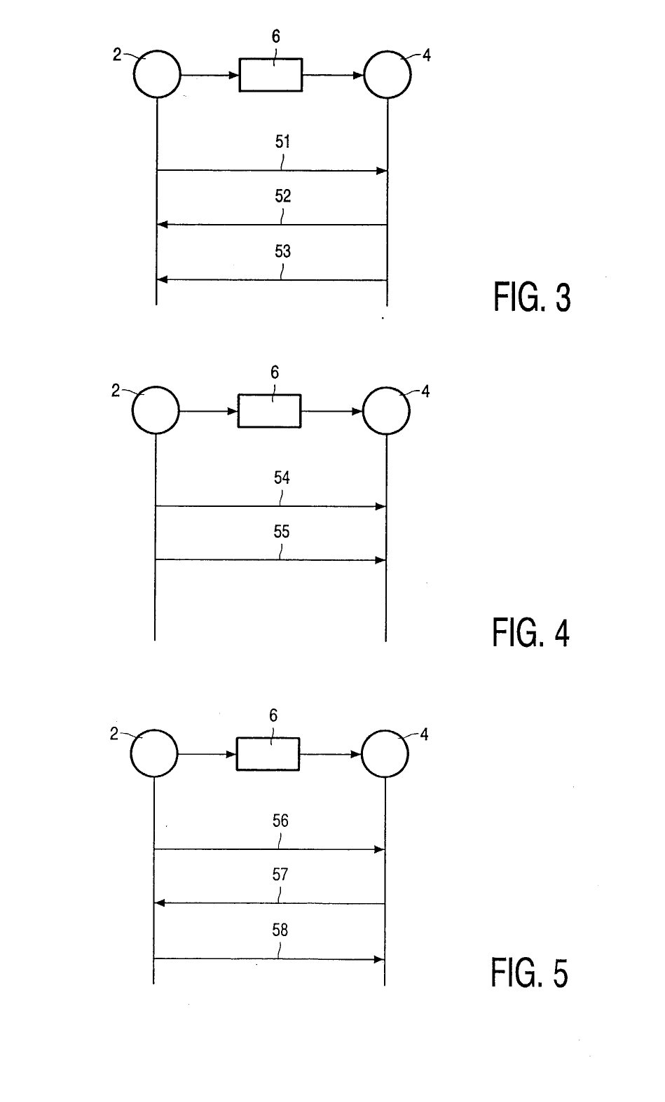

FIGS. 3-5 are diagrams of another embodiment according to the present invention;

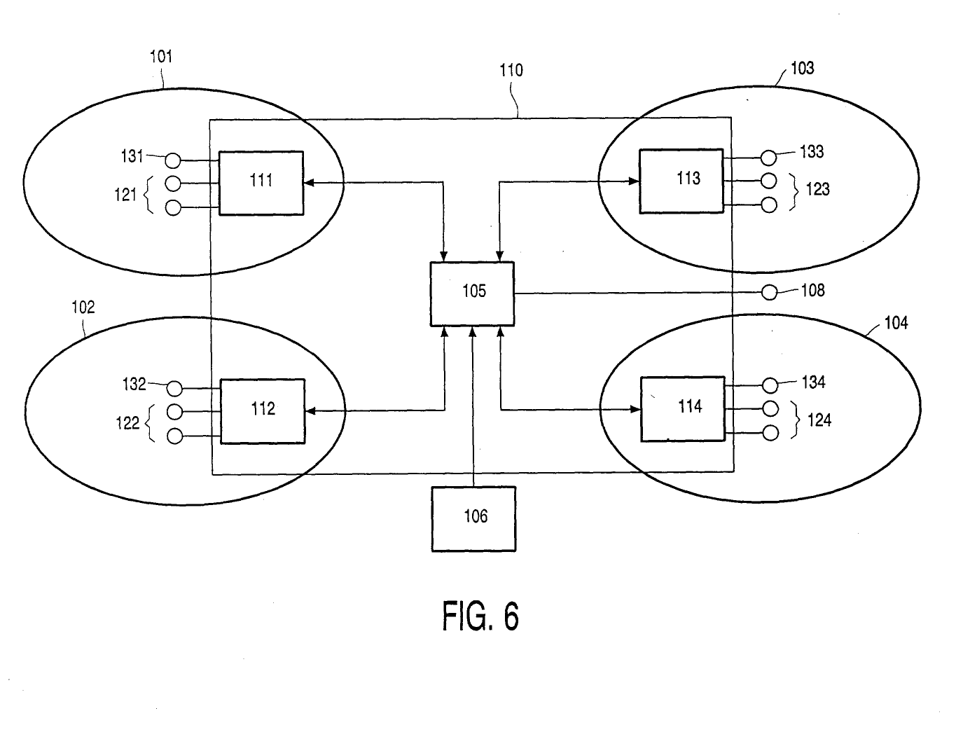

FIG. 6 is a diagram of another preferred embodiment according to the invention.

In an embodiment (FIG. 1) two processes 2,4 need to exchange data during operations. For this purpose they logically make use of connectors 6,8. Two connectors are shown, but in both directions an array of connectors may be available. Such an array can be described as Xᵢ for connector 6 and Yᵢ for connector 8. Connectors are equipped with indicators (flags) 16,18. While the connectors 6,8 represent a logical model by which processes communicate, the physical data communications are performed using interaction managers 12,14 and one or more data communications networks N. In the embodiment of FIG. 6 the interaction managers 12,14 are part of the co-clients 111,112,113,114 which will be described in relation to FIG. 6.

Processes use connectors by issuing COMMIT or SYNC commands to their interaction managers. In order to avoid the use of polling, an interaction manager can notify a process that certain input connectors Y₁, . . . , Yₘ have been enabled. The operator SIGNAL (Y₁, . . . , Yₘ) does this. It can e.g. be used to implement the WAIT operator described in the above. Interaction managers can communicate with other interaction managers through the network. Two operations are defined for this. An interaction manager of a sender process s can use the operation SEND (m,r) to send a message m which arrives at the receiver, the network will call the method DELIVER (m,s) of the interaction manager of the receiver, where s is the sender process.

Object types that are used for specifying the method are process for processes, connector for connector, value for values, connector state for output connector states, SYNC n,r for sequence numbers, message for messages. The type Process corresponds to the class of processes. The type connector represents the class of connectors. Instances of this type are used as “identities” (e.g. in messages) as well as objects that have state variables (see the slide on “connector variables”). The data type Value represents the values that can be stored in connectors. ConnectorState is an enumerated type defining the control states of output connectors, i.e. the states of connectors as perceived by the sender of the connector. They are further discussed below. Values of type SeqNr are integers that are used as sequence numbers for COMMITs. Values of type Message represent the messages that can be sent and received by interaction managers. The various kinds of messages that are used are defined later.

An embodiment according to the invention (FIG. 2) consists of four states:

| | |
|---|---|
| committed 42: | no COMMIT in progress on x |
| committing 41: | COMMIT of type COMMIT (x ← v) in progress on x, |
| | all COMMITs initiated before this one are complete |
| locking 43: | COMMIT of type COMMIT (x₁← V₁,...,xₘ← Vₘ) in |
| | progress on x; COMMIT is in phase 1 |
| locked 44: | COMMIT of type COMMIT (x₁← V1,...,xₘ← Vₘ) in |
| | progress on x; COMMIT is in phase 2 |

The interaction manager of a process maintains a “state” for each of the output connectors of the process. This state can have four different values with an interpretation as described below. If an output connector is in the “committed” state there is no COMMIT in progress on the connector. The connector is not locked. If an output connector x is in the “committing” state, the execution of a COMMIT of type COMMIT (x←v) 46 is in progress on it, while all preceding COMMITs have been completed. The connector is not locked and the sender process is awaiting a “committed” message from the receiver process to complete the COMMIT. If an output connector is in the “locking” state, there is a COMMIT of type COMMIT (x₁←V1, . . . , xₘ←Vₘ) 49 which is not synchronized in progress with the COMMIT being in phase 1 of the two-phase locking scheme. The connector may already be locked or not and the sender process is awaiting a “locked” message from the receiver process to go to phase 2 of the two-phase locking scheme. If an output connector is in the “locked” state, there is a COMMIT of type COMMIT (x₁←V1, . . . , xₘ←Vₘ) 47 which is synchronized in progress with the COMMIT being in phase 2 of the two-phase locking scheme. The connector is locked and the sender process is awaiting the condition that all output connectors x₁, . . . , xₘ are locked and all preceding COMMITs have been completed so as to complete the COMMIT.

In this embodiment several type of messages are being used by the method, which are:

From sender to receiver:

<commit, Connector, Value>

<lock1, Connector, Value>

<lock 2, Connector, Value>

<unlock, Connector>

From receiver to sender:

<committed, Connector>

<locked, Connector>

<synced, Connector>

A message is a multiple of values, where the first element of the multiple indicates the type of message.

The <commit,x,v>51 message is a command to the receiver of connector x to write v into x, enable x, and send back a <committed, x>52 message to the sender process.

The <lock1,x,v>54 message is a command to the receiver of connector x to write v into x, enable and lock x, without sending a message back to the sender process.

The <lock2,x,v>56 message is a command to the receiver of connector x to write v into x, enable and lock x, and send back a <locked,x>57 message to the sender process.

The <unlock,x>55,58 message is a command to the receiver of connector x to unlock connector x. It is used when completing a COMMIT. The <committed,x>52 and <locked,x>57 messages are acknowledgement messages of the receiver of x as discussed above. The <synced,x>53 message is sent by the receiver of x to the sender of x when a successful “sync” has been performed on x, i.e. when the value of x has been read and x has been disabled.

In order to control the execution of COMMITs and SYNCs records are being maintained by an interaction manager, comprising this set of interaction manager variables:

| | |
|---|---|
| inputs: Set (Connector) | set of input connectors (constant) |
| outputs: Set (Connector9 | set of output connectors (constant) |
| current: SeqNr | seqnr of last initiated COMMIT |
| complete: SeqNr | seqnr of last completed COMMIT |
| conset [SeqNr]: | |
| Set(Connector) | conset [s] is the set of connectors |
| | involved in the COMMIT with seqnr s |

Initially

current=0

complete=0

conset=not relevant

These records consist of two parts. First of all, the interaction manager maintains information about the status of each input connector and output connector attached to the process. This information is preferably stored in objects representing the connectors; the variables contained in these objects are discussed below. Secondly there are a number of global variables in the interaction manager itself as indicated. The information about the connectors that are connected as inputs and outputs to the process are contained in the constant collections (sets) of objects inputs and outputs. In order to keep track of the COMMITs in progress, sequence numbers for COMMITs are used. The variable current is the sequence number of the most recently initiated COMMIT. The variable complete is the sequence number of the most recently completed COMMIT (so complete≦current). For each COMMIT in progress, i.e. each COMMIT with sequence number s so that complete<s≦current, the interaction manager should know which connectors are involved in the COMMIT. This information is stored in the (potentially infinite) array conset. In another embodiment, the data structure comprised by current, complete and conset can be replaced by a very efficiently linked list structure through the connector objects (eliminating the need for sequence numbers).

An interaction manager records information about each input and output connector which are stored in separate objects representing these connectors, the variables being:

| | |
|---|---|
| sender : Process | sender process attached to connector (constant) |
| value : Value | current value stored in connector |
| enabled: Boolean | indicates if connector is enabled |
| locked: Boolean | indicates if connector is locked |

Initially

value=not relevant

enabled=false

locked=false

The constant sender refers to the sender process of the connector (the process at the other end of the connector). The variable value contains the value stored in the connector, which, as discussed before, is stored at the receiver side of the connector. The “flags” enabled and locked indicate whether the connector is enabled and locked, respectively.

Furthermore, the interaction manager records information about each input and output connector which is stored in separate objects representing these connectors, the variables being:

| | |
|---|---|
| receiver: Process | receiver process attached to connector (constant) |
| state: ConnectorState | current output control state of the connector |
| synced: Boolean | indicates if connector is known to be disabled |

Initially

state=committed

synced=true

The constant receiver refers to the receiver process of the connector (the process at the other end of the connector). The variable state is used to maintain the “control state” of the output connector. The value of this variable defines the status of the output connector and determines to a large extent which actions will be taken by the interaction manager on this connector. For a discussion of the various possible connector states and their interpretation see below. The “flag” synced indicates whether the connector is known to be disabled (as reported by the receiver using a “synced” message). Below detailed definitions of the COMMIT, SYNC and DELIVER operations that can be applied to interaction managers are described.

A SYNC example of the operative COMMIT is:

| | |
|---|---|
| operation COMMIT (x₁ ← V1,...,xₘ ← Vₘ) | (1) |
| precondition {x₁,...,xₘ} ? outputs and m ≧1 | (2) |
| action | (3) |

| | |
|---|---|
| await forall x : {x₁,...,xₘ} x.state = committed | (4) |
| if m = 1 and current = complete | (5) |

| | |
|---|---|
| SEND (<commit, x₁,v₁>, x₁.receiver) | (6) |
| x₁.state :=committing | (7) |

| | |
|---|---|
| else | (8) |

| | |
|---|---|
| for i : {1,...,m} | (9) |

| | |
|---|---|
| if xᵢ.synced | (10) |

| | |
|---|---|
| SEND (<lock1, xᵢ,vᵢ>, xᵢ.receiver) | (11) |
| xᵢ.state :=locked | (12) |

| | |
|---|---|
| else | (13) |

| | |
|---|---|
| SEND (<lock2, xᵢ,vᵢ>, xᵢ.receiver) | (14) |
| xᵢ.state :=locking | (15) |

| | |
|---|---|
| current := current + 1 | (16) |
| conset [ current ] := {x₁,...,xₘ} | (17) |

The precondition (2) of COMMIT states that x₁, . . . , xₘ should be outputs of the current process and that COMMIT should involve at least one output. If a COMMIT is in progress on any of the output connectors x₁, . . . , xₘ, as indicated by the state of the connector being unequal to “committed”, the process should wait until all COMMITs on x₁, . . . , xₘ are completed, i.e. all x₁, . . . , xₘ are in the “committed” (4) state. This happens through the effect of incoming DELIVER commands. If a COMMIT is of type COMMIT (x₁←V₁) 46 and all preceding COMMITs have been completed (condition “current=complete” on line (5)), then the message <commit, x₁, V₁> is sent to the receiver x₁ thereby instructing the receiver to store the value V₁ in x₁, enable x₁ and send the acknowledgement <committed, x₁> to the sender (6). Until the acknowledgement is received, the state of the connector is set to “committing”(7) 41. In all other situations a two-phase locking scheme is used.

All output connectors x₁, . . . , xₘ involved in the COMMIT (9) are traversed and each xᵢ is locked at the receiver side of the connector. This is done by sending each xᵢ a “lock” message of which there are two types: “lock1” and “lock2” (11,14). For performance reasons, both types of messages are used to transport the value Vᵢ to the receiver even though Vᵢ cannot yet be read by the receiver. (By moving Vᵢ to the receiver in the “lock” message, the message does not need to be buffered and only an “unlock” message, without data having to be sent to the receiver when completing the COMMIT.) If the synced flag of xᵢ is set (10) the connector is disabled and cannot be read nor enabled at the receiver side, hence the state of the connector can be set to “locked” immediately (12). The “lock1” message indicates to the receiver that it does not have to send an acknowledgement that the connector has been locked. If the synced flag of xᵢ is not set (13) the regular two-phase locking scheme is to be followed. The “lock2” message sent to the receiver (14) instructs the receiver to send an acknowledgement (a “locked” message) when the connector is locked. Until that message is received, the state of the connector is set to “locking”. COMMIT finishes by incrementing the sequence number of the currently active COMMIT (16) and recording the connectors involved in the current COMMIT (17) for later reference.

A syntax example of the operative SYNC is as follows:

| operation SYNC (x₁,...,xₙ) | | (1) |
|---|---|---|
| precondition {x₁,...,xₙ} ? inputs | | (2) |
| action | | (3) |
| | if current ≠complete and {decide to await COMMIT completion} | (4) |

| | |
|---|---|
| await current = complete | (5) |

| | |
|---|---|
| else return | (6) |

| | |
|---|---|
| for x : {x₁,...,xₙ} where x.enabled | (7) |

| | |
|---|---|
| if not x.locked or (x.locked and {decide to await | |
| COMMIT unlocking} | (8) |

| | |
|---|---|
| await not x.locked | (9) |
| read x.value | (10) |
| x.enabled := false | (11) |
| SEND (<synced, x >, x.sender) | (12) |

The precondition (2) of SYNC states that x₁, . . . , xₘ should be inputs of the current process. Before letting SYNC be read from any of the enabled connectors all COMMITs should have finished, otherwise sequential inconsistency may arise. However, if not all COMMITs have finished, i.e. current ≠complete, it is an option to wait for this (4,5) or to exit SYNC without reading from any disabled connector (6). The latter is allowed by the present definition of SYNC and can be useful when blocking of SYNC is not desirable. On the other hand, the fairness requirement may at some time require waiting for the COMMITs to complete. When all COMMITs have been completed, the enabled output connectors in the set {x₁, . . . , xₙ} are traversed (7). If a connector is not locked, or if it is locked and it is decided to wait for it to be unlocked (8,9), the value of the connector is read (10). Note that the choice to wait for the unlocking or not is allowed by the relaxed SYNC definition; waiting may be required in connection with fairness. When the value of the connector has been read, the connector should be disabled (11) and the sender of the connector should be informed of this by sending a synchronized message (12).

Another embodiment of this definition of SYNC is to let SYNC use knowledge of the network topology to read from one or more of the x₁, . . . , xₙ, even though not all COMMITs have been completed (assuming the topology is such that sequential consistency is guaranteed).

Several syntax examples of the operative DELIVER are now being introduced:

| | |
|---|---|
| operation DELIVER (< commit,x,v >) | (1) |
| precondition x ε inputs and not x.locked | (2) |
| action | (3) |

| | |
|---|---|
| x.value :=v | (4) |
| x.enabled :=true | (5) |
| SEND (< committed, x >,x.sender | (6) |
| SIGNAL (x) | (7) |

This network operation delivers a “commit” message to the interaction manager of the current process. The protocol is such that the connector x in the message is an input of the current process and that the message is delivered when x is not locked (2). The message instructs the interaction manager to store the value v contained in the message in the connector x (4), set the enabling flag of the connector (5), and send an acknowledgement to the sender of the message (6). The SIGNAL command alerts the current process that connector x has been enabled.

Another syntax example of DELIVER is:

| | |
|---|---|
| operation DELIVER (< lock1,x,v >) | (1) |
| precondition x ε inputs and not x. locked | (2) |
| action | (3) |

| | |
|---|---|
| x.value :=v | (4) |
| x.enabled :=true | (5) |
| x.locked :=true | (6) |

This network operation delivers a type 1 “lock” message to the interaction manager of the current process. The protocol is such that the connector x in the message is an input of the current process and that the message is delivered when x is not locked (2). The message instructs the interaction manager to store the value v contained in the message in the connector x (4), set the enabling flag of the connector (5), and lock the connector (6). The difference with a type 2 “lock” message is that no acknowledgement is sent to the sender of the message.

Another syntax example of the operative DELIVER is:

| | |
|---|---|
| operation DELIVER (< lock2,x,v >) | (1) |
| precondition x ε inputs and not x.locked | (2) |
| action | (3) |

| | |
|---|---|
| x.value :=v | (4) |
| x.enabled :=true | (5) |
| x.locked :=true | (6) |
| SEND (< locked, x >,x.sender) | (7) |

This network operation delivers a type 2 “lock” message to the interaction manager of the current process. The protocol is such that the connector x in the message is an input of the current process and that the message is delivered when x is not locked (2). The message instructs the interaction manager to store the value v contained in the message in the connector x (4), set the enabling flag of the connector (5), lock the connector (6), and send an acknowledgement to the sender of the message (7). The difference with a type 1 “lock” message is in the acknowledgement being sent to the sender of the message.

Another syntax example of the operative DELIVER is:

| | |
|---|---|
| operation DELIVER (< unlock,x, >) | (1) |
| precondition x ε inputs and x.enabled and x.locked | (2) |
| action | (3) |

| | |
|---|---|
| x.locked :=false | (4) |
| SIGNAL (x) | (5) |

This network operation delivers an “unlock” message to the interaction manager of the current process. The protocol is such that the connector x in the message is an input of the current process and that the message is delivered when x is enabled and locked (2). The message instructs the interaction to unlock the connector x (4). The SIGNAL command alerts the current process that connector x has been unlocked and can be read (because it is enabled).

Another SYNC example of de operative DELIVER is:

| operation DELIVER (< committed,x >) | | (1) |
|---|---|---|
| precondition x ε outputs and not x.locked and x.state = committing | | (2) |
| action | | (3) |
| | x.state :=committed | (4) |
| | x.synced :=false | (5) |
| | complete :=complete + 1 | (6) |
| | COMPLETE ( ) | (7) |

This network operation delivers a “committed” message to the interaction manager of the current process. The protocol is such that the connector x in the message is an output of the current process and that the message is delivered when x is not locked and the state of x is “committing” (2). The message instructs the interaction manager to change the state of the connector x to “committed” (4) and set the synced flag to false (5). The “committed” message reports completion of a COMMIT of type COMMIT (x→v), whose sequence number is equal to (complete+1) (this is a property implied by the protocol). The value of complete is adjusted in agreement with this (6). The completion of the COMMIT may enable the completion of other COMMITs initiated after this COMMIT, which is checked by an auxiliary operation COMPLETE( ) (7) which will be described below.

Another SYNC example of the operative DELIVER:

| | |
|---|---|
| operation DELIVER (< locked,x >) | (1) |
| precondition x ε outputs and x.locked and x.state = locking | (2) |
| action | (3) |

| | |
|---|---|
| x.state :=locked | (4) |
| COMPLETE ( ) | (5) |

This network operation delivers a “locked” message to the interaction manager of the current process. The protocol is such that the connector x in the message is an output of the current process and that the message is delivered when x is locked and the state of x is “locking” (2). The message instructs the interaction manager to change the state of the connector x to “locked” (4), which may allow one or more COMMITs in progress to be completed. This is checked by the auxiliary operation COMPLETE ( ) (5) which will be described below.

Another SYNC example of the operative DELIVER is:

| | |
|---|---|
| operation DELIVER (< synced,x >) | (1) |
| precondition x ε outputs | (2) |
| action | (3) |

| | |
|---|---|
| if x.state = committed | (4) |

| | |
|---|---|
| x.synced :=true | (5) |

This network operation delivers a “synced” message to the interaction manager of the current process. The protocol is such that the connector x in the message is an output of the current process. The message instructs the interaction manager to change the value of the synced flag of x to “true” (5) provided that x is in the “committed” state (4). If x is not in the “committed” state the message is ignored because only if x is in the “committed” state are we sure that x has been “synced”, i.e. that the enable flag of x has been cleared.

In one embodiment use is made of an operative COMPLETE ( ):

| operation COMPLETE( ) | | (1) |
|---|---|---|
| precondition true | | (2) |
| action | | (3) |
| | while complete < current and | (4) |

| | |
|---|---|
| (forall y : conset [complete + 1] y.state = locked | (5) |
| for y : conset [complete + 1] | (6) |

| | |
|---|---|
| SEND (<unlock, y>, y.receiver | (7) |
| y.state := committed | (8) |
| y.synced := false | (9) |

| | |
|---|---|
| complete := complete + 1 | (10) |

COMPLETE is an auxiliary operation that checks whether one or more of the COMMITs in progress are ready to be completed and if so, it completes these COMMITs. It checks first of all whether there are any COMMITs in progress at all (4) and whether the first COMMIT that should be completed (the COMMIT with sequence number complete+1) is allowed to complete, i.e. whether all connectors involved in the COMMIT are in the “locked” state (5). If so, these connectors are traversed (6) and an “unlock” message is sent to the receiver of each connector (7). The completion of the COMMIT is recorded in the connector by changing its state to “committed” (8) and the value of the synced flag is reset to false (9). Finally the variable complete, indicating the sequence number of the most recently completed COMMIT is incremented (10). Since the completion of the COMMIT may enable the completion of the next COMMIT that is in progress, the whole process is repeated (4). Note that completion of a COMMIT of type COMMIT (x→v) is not handled by COMPLETE but directly by the DELIVER (<committed, x>) operation.

1. A method for obtaining sequential consistency of data communications using a ‘commit-sync’ execution model, comprising the steps of:
transmitting data from a first process to an intermediate object or part thereof by a commit command,
setting an indicator of the intermediate object or part thereof to an indication that data is to be received or accessed by a second process,
receiving or accessing the data from the intermediate object by the second process by a sync command,
setting the indicator of the intermediate object or part thereof to an indication that no data is to be received or accessed by the second process, wherein
the commit command and/or the sync command is provided with one or more parameters to indicate in what way the data are transmitted to and/or received or accessed from the intermediate object, respectively.

2. A method according to claim 1, wherein the intermediate object for conveying the data is associated with one sending and one receiving process.

3. A method according to claim 1 in which operations that are performed on the intermediate objects or part thereof are atomic.

4. A method according to claim 1 in which the parameters specify which data is handled by which intermediate object or part thereof.

5. A method according to claim 1 in which a receiving operation can access any intermediate object or parts thereof.

6. A method according to claim 1 in which a receiving operation can access such intermediate object or parts thereof to which a transmitting operation has sent data.

7. A method according to claim 1 in which a receiving operation can access such intermediate objects or parts thereof to which no data has been sent by a transmitting operation.

8. A method according to claim 1 in which a receiving operation eventually accesses all intermediate objects or parts thereof to which a transmitting operation has sent data.

9. A method according to claim 1 in which a receiving operation reports reception of data to the transmitting operation that sent the data.

10. A method according to claim 1 in which processes continue processing while transmitting.

11. A method according to claim 1 in which processes use an interaction manager for managing transmitting and receiving operations.

12. A method according to claim 1 in which more than one transmitting operation is performed by a process.

13. A method according to claim 1 in which an indicator is set immediately after a transmission in the event that no other transmission was in progress when the transmission started.

14. A method for exchanging data between two or more program threads running on one or more computing devices each including a processor and at least some memory, said method comprising the following steps:
a first of said program threads executes a contractual software component for defining a relation between said threads;
said first program thread and one or more second program threads each create respective contractual software objects on the basis of the defined relation of said contractual software component.

15. A method according to claim 14 wherein the defined relation between said threads is an instantiation of the contractual software component.

16. A method according to claim 14 in which a contractual software object is created for every program thread.

17. A method according to claim 14 in which a contractual software object is created for each thread using the method for exchanging data by allocating the necessary means for creating and operating said contractual software object.

18. A method according to claim 14 in which the contractual software object and the relationship between said threads is a single logical object.

19. A method according to claim 14 in which a program thread operates locally on a first contractual software object for communicating data to a second thread by means of a latter's second contractual software object.

20. A method according to claim 14 in which a local operation on said first contractual software object of said single logical object becomes global after a commit operation of said first contractual software object.

21. A method according to claim 14 in which a global operation of said first contractual software object of said single logical object takes effect on a second contractual software object by means of calling a sync operation by said second contractual software object.

22. A method according to claim 1 using a method according to claim 14.

23. A method according to one or more of the preceding claims in which intermediate objects or parts thereof are connectors.

24. A computer system, comprising at least one computing device with at least one processor and one memory running at least two concurring program threads that need to exchange information, for performing a method according to one or more of the claims 1-23.
